(19) United States
(12) Patent Application Publication
(10) Pub. No.: US 2024/0315488 A1
(43) Pub. Date: Sep. 26, 2024

(54) Method and Apparatus for a Blender

(71) Applicant: Midea Group Co., Ltd., Beijiao (CN)

(72) Inventors: Paul R. Staun, Sharonville, OH (US); Hunter J. Butler, Louisville, KY (US)

(21) Appl. No.: 18/187,915

(22) Filed: Mar. 22, 2023

(51) Int. Cl. A47J 43/07; A47J 43/046; A47J 43/08

(52) U.S. Cl. CPC A47J 43/0722; A47J 43/046; A47J 43/085

(57) ABSTRACT

A blade assembly for a blender. The blade assembly may include one or more blades. The blade assembly may include one or more bushings. The blade assembly may include one or more washers. The blade assembly, or portions thereof, may travel along a portion of the shaft between elevations. A tamper may used to adjust the elevation of the blade assembly, or portions thereof.

### BACKGROUND

The present embodiments relate to a blender, more specifically for a movable blade(s) for use in a blender.

Typically blender blade(s) are fixed in elevation within the container to blend and/or chop foods and liquids. However, the contents within the container may not be completely blended such as, but is not limited to, when the contents adhere to the side walls and/or when contents maintain a position above the blade(s). Thus, there is a need to increase the efficiency of blending the content(s) within the blender container.

### SUMMARY

In some embodiments of the invention, for example, a blender may include a base having a drive mechanism. In various embodiments, the blender may include a shaft rotatably driven by the drive mechanism. In some embodiments, the blender may include a blade assembly having a bushing and one or more blades. In various embodiments, the bushing may be positioned between the one or more blades and the shaft. In some embodiments, the bushing and the one or more blades may be rotatably driven with the shaft by the drive mechanism. In various embodiments, the blender may include a container removably attached to the base. In some embodiments, the container may include at least a portion of the shaft and the blade assembly therein. In various embodiments, the bushing and/or the one or more blades may vertically travel along the shaft when rotatably driven with the shaft.

In some embodiments, the blender may include an upper member and a lower member positioned on the shaft. In various embodiments, upward vertically travel of the bushing and the one or more blades may be stopped by the upper member and downward vertically travel of the bushing and the one or more blades may be stopped by the lower member. In various embodiments, the bushing may directly abut the upper member and the lower member when upward vertical travel and downward vertical travel is stopped, respectively. In some embodiments, the upper member and the lower member may be vertically fixed along the shaft and/or rotatable relative to the shaft. In various embodiments, the blade assembly may include a washer vertically traveling along the shaft with the bushing and the one or more blades. In some embodiments, the washer freely rotates relative to the shaft. In some embodiments, the blender may include a tamper and wherein the container includes a lid defining an opening, wherein the lid may be removably attached to the container, and wherein the tamper extends through the opening of the lid and releasably engages the washer to drive the washer, the bushing, and the one or more blades vertically downward along the shaft. In various embodiments, the tamper may include a distal end and a proximal end, wherein the proximal end includes a receptacle, and wherein the proximal end releasably engages the washer when the receptacle of the proximal end receives the shaft, a length of the shaft within the receptacle increases as the tamper drives the washer, the bushing, and the one or more blades vertically downward along the shaft. In some embodiments, the bushing may include an upper portion and a lower portion. In various embodiments, an outer periphery of the upper portion may be smaller than an outer periphery of the lower portion defining a step therebetween. In some embodiments, the one or more blades may include a top surface and a bottom surface with a through opening therebetween. In various embodiments, the through opening may contact the outer periphery of the upper portion of the bushing and the bottom surface may contact the step of the bushing. In some embodiments, the bushing may rotationally lock to the shaft while allowing vertical travel along the shaft. In various embodiments, the one or more blades may rotationally lock to the bushing while allowing vertical travel along the shaft.

In various embodiments, a blender blade assembly may include one or more bushings. In some embodiments, the blender blade assembly may include one or more blades. In various embodiments, the one or more blades may engage the one or more bushings. In some embodiments, the one or more bushings and/or the one or more blades are configured to be rotational fixed to and/or vertically travel along a shaft.

In addition, in some embodiments, the blender blade assembly may include a washer. In various embodiments, the washer may be configured to vertically travel along a shaft with the one or more bushings and the one or more blades. In some embodiments, the washer may freely rotate relative to the one or more bushings. In various embodiments, the bushing may include an upper portion and a lower portion. In some embodiments, an outer periphery of the upper portion may be smaller than an outer periphery of the lower portion defining a step therebetween. In various embodiments, the one or more blades may include a top surface and a bottom surface with a through opening therebetween. In some embodiments, the through opening may contact the outer periphery of the upper portion of the bushing and the bottom surface contacts the step of the bushing. In various embodiments, the blender blade assembly may include a shaft having an upper member and a lower member positioned on the shaft. In some embodiments, upward vertically travel of the one or more bushings and/or the one or more blades is stopped by the upper member and downward vertically travel of the one or more bushings and/or the one or more blades is stopped by the lower member. In various embodiments, the one or more bushings may directly abut the upper member and the lower member when upward vertical travel and downward vertical travel is stopped, respectively. In some embodiments, the upper member and/or the lower member may be vertically fixed along the shaft and/or rotatable relative to the shaft. In various embodiments, the blender blade assembly may include a base, a drive mechanism, and/or a container.

In various embodiments, a method of mixing the contents of a blender container may include providing a blender having a base and a container removably attached to the base. In some embodiments, the base may include a drive mechanism. In various embodiments, the container may include a lid defining an opening. In some embodiments, the lid may be removably attached to the container. In various embodiments, the method may include providing a blade assembly engageable to the drive mechanism of the base. In various embodiments, the blade assembly may have a bushing and/or one or more blades. In some embodiments, the bushing may be positioned between the one or more blades and the shaft. In various embodiments, the method may include rotatably driving the bushing and the one or more blades with the shaft by the drive mechanism. In some embodiments, the method may include vertically moving the bushing and/or the one or more blades upwardly when rotatably driven.

In addition, in some embodiments, the method may include inserting a tamper through the opening of the lid into an interior of the container, engaging the blade assembly with the tamper, and vertically moving the bushing and the one or more blades downwardly when rotatable driven with the tamper. In various embodiments the method may include increasingly telescoping the shaft relative to the tamper when vertically moving the bushing and the one or more blades downwardly when rotatable driven with the tamper. In some embodiments, the method may include stopping the vertical movement of the blade assembly with an upper member and a lower member positioned on the shaft. In various embodiments, the blade assembly includes a washer vertically traveling along the shaft with the bushing and the one or more blades.

These and other advantages and features, which characterize the embodiments, are set forth in the claims annexed hereto and form a further part hereof. However, for a better understanding of the embodiments, and of the advantages and objectives attained through its use, reference should be made to the Figures and to the accompanying descriptive matter, in which there is described example embodiments. This summary is merely provided to introduce a selection of concepts that are further described below in the detailed description, and is not intended to identify key or essential features of the claimed subject matter, nor is it intended to be used in limiting the scope of the claimed subject matter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a perspective view of one embodiment of a blender, and illustrating an embodiment of a blade assembly at a first/lower elevation or position along the shaft;

FIG. 2 is a sectional view of the blender and blade assembly taken along line 2-2 of FIG. 1 illustrating the blade assembly sliding relative to the shaft to a second/higher elevation or position;

FIG. 3 is a sectional view of the blender and blade assembly of FIG. 2 illustrating the blade assembly sliding relative to the shaft to a third/higher elevation or position and/or engaging the upper stop mechanism, and illustrating a tamper engaged with the blade assembly;

FIG. 4 is a sectional view of the blender and blade assembly of FIG. 3 illustrating the blade assembly sliding relative to the shaft to the first/lower elevation or position and/or engaging the lower stop mechanism, and illustrating the tamper engaged with the blade assembly and increasing the length of the shaft engaged/received therein; and

FIG. 5 is an exploded view of the blade assembly, shaft, and tamper of FIG. 4.

### DETAILED DESCRIPTION

Numerous variations and modifications will be apparent to one of ordinary skill in the art, as will become apparent from the description below. Therefore, the invention is not limited to the specific implementations discussed herein.

The embodiments of the blender blade assembly 20 discussed hereinafter will focus on the implementation of the hereinafter-described techniques and apparatuses within a device and/or appliance such as a blender 10, or in other similar applications. However, it will be appreciated that the herein-described techniques and apparatuses may also be used in connection with other types of appliances/devices having mixing volumes/compartments/spaces/blades in some embodiments. In the one embodiment shown in the figures, the blade assembly 20, or portions thereof, may include one or more blades (e.g. first 30a, second, etc.), one or more bushings 40, a shaft 60, and/or one or more washers 50. In some embodiments, the blade assembly 20 may include one or more blenders 10, or portions thereof. In the one embodiment shown, the blender 10, if used, may include a base 11 with a drive mechanism 12 (e.g. motor), and a blender container 13 with an operable blade or mixing assembly 20 (e.g. one or more blades 30) therein. The container 13 may include an interior 13a defined by one or more surfaces (e.g. lid, container, or portions thereof). The blade assembly 20 is engageable to the drive mechanism 12. The container 13 may be removably attached to the base 11. The container 13, if used, may include a lid 15 removably attached to cover the container 13. The lid 15 may define an opening 16 therethrough to access the interior 13a of the container/lid volume. In various embodiments, the blender 10 may include one or more tampers 70. If and when the tamper 70 is not engaging or uninstalled with the lid 15, the blender or lid 15 may include a cover 14 to removably engage the opening 16 of the lid 15 between a closed position and an open position. Control over blender 10 by a user is generally managed through a control panel or controls 17 typically disposed on a top or front of base 11, and it will be appreciated that in different blender designs, the control panel 17 may include various types of input and/or output devices, including various knobs, buttons, lights, switches, textual and/or graphical displays, touch screens, etc. through which a user may select/configure one or more settings and start/stop one or more blending cycles (e.g. clockwise rotation, counterclockwise rotation) of the blender.

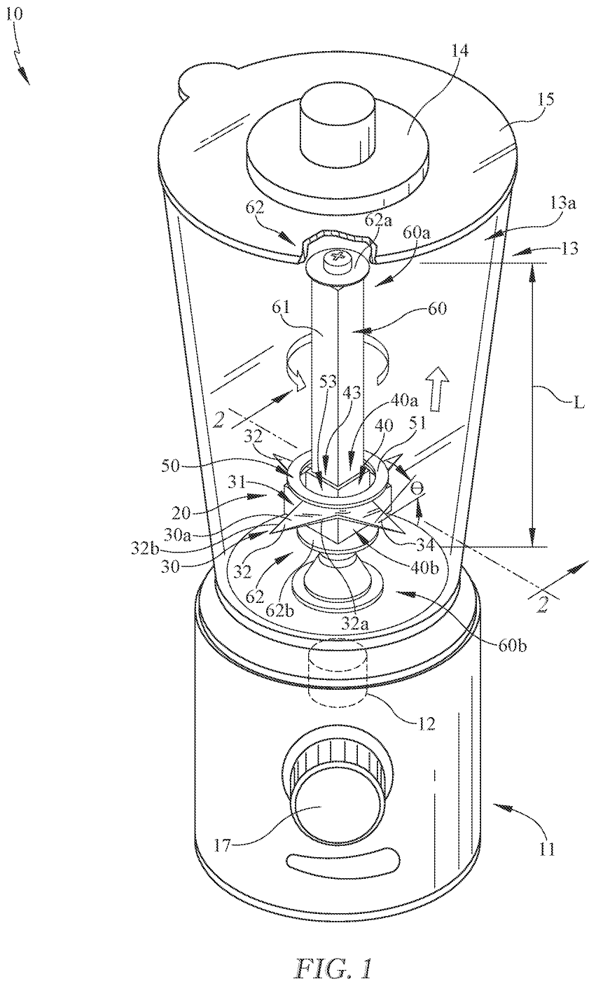

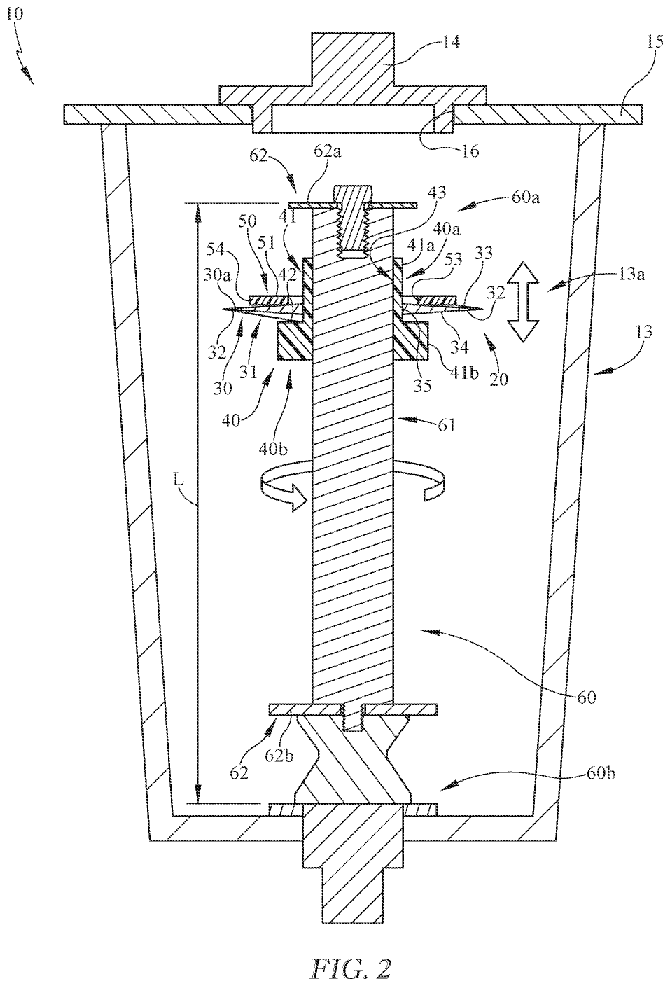

In some implementations, the blender 10 and/or blade assembly 20, or portions thereof, may be positionable (e.g. within the container) between a plurality of elevations/positions to mix the contents therein. As shown in FIGS. 1-4, the blade assembly 20, or portions thereof, may travel/slide/move between elevations (e.g. upwardly and/or downwardly) when the drive mechanism is rotatably driving the blade assembly 20 and/or shaft 60, or portions thereof. The blade assembly 20, blades 30, bushing 40, and/or washer 50 may travel upwardly along the shaft 60 when the shaft 60/drive mechanism 12 is rotating. The blade assembly 20, or portions thereof, (e.g. blades) may be shaped that pushes down on the contents (e.g. food, liquid) inside the container 13. The pushing down effect or forces may cause the blade assembly 20 (e.g. blades, bushing, washer) to move/slide upward inside the container along the shaft. For example, in the one embodiment shown in the figures, the front or leading edge 32a of the one or more blades 30/protrusions 32 may be at a higher elevation than the trailing edge 32b in at least one rotational direction. There may be at least one angle θ between at least one leading edge 32a and at least one trailing edge 32b. When the angle θ is increased from the horizontal plane, the rising effect or speed of upward travel of the blade assembly 20, or portions thereof, may increase and/or go faster. Alternatively when the angle θ is decreased from the horizontal, the rising effect or speed of upward travel of the blade assembly 20 may decrease or go slower. The angle θ may be about 30 degrees to about 45 degrees between the trailing edge and the leading edge in some embodiments. One or more portions of the blade assembly 20 and/or portions of the blender 10 may be rotational fixed to the shaft 60 while still allowing travel/sliding (e.g. linear, axial, vertical) between elevations (e.g. upwardly and/or downwardly). When the shaft 60/drive mechanism 12 is rotating (e.g. at least one rotational direction), the blade(s) 30 and/or bushing 40 may rotate with the shaft 60/drive mechanism 12 when changing elevation (e.g. upwardly and/or downwardly) or at an elevation. Although the washer 50, if used, is shown in the one embodiment as not rotating with the shaft/drive mechanism while changing elevation, it should be understood the washer 50 may rotate with the shaft/blade/bushing/assembly in some embodiments. The blade assembly 20, blade 30, bushing 40, and/or washer 50 may travel downwardly along the shaft 60 when the shaft 60/drive mechanism 12 is rotating. The blade assembly 20, blade 30, bushing 40, and/or washer 50 may travel/slide downwardly along the shaft when manually moved/forced downwardly by the user/tamper 70 when there is rotation of the shaft/drive mechanism. Further, in some embodiments, the blade assembly, or portions thereof, may travel between elevations (e.g. downwardly) when the drive mechanism is not rotating the blade assembly and/or shaft, or portions thereof. The blade assembly, blade, bushing, and/or washer may travel/slide downwardly along the shaft when there is no rotation of the shaft/drive mechanism. In some embodiments, reversing the direction of rotation may drive/force the blade assembly downwardly along the shaft. In some embodiments, a bias mechanism (not shown) may urge the blade assembly, or portions thereof, upwardly and/or downwardly along the shaft. For example, the bias mechanism may be one or more springs.

In some implementations, the blade assembly 20 and/or blender 10, or portions thereof, may include at least one shaft 60. The shaft 60 may be elongated having an upper/first end 60a and an opposing lower/second end 60b. The shaft 60 may include a length L between the upper end 60a and the lower end 60b. The shaft 60 may be positioned (e.g. vertically) in the blender/container 13. The shaft 60 and/or blade assembly 20, or portions thereof, may be rotatably driven by or connected to the drive mechanism 12 in the clockwise direction and/or counterclockwise direction. Although the shaft 60 is shown as rectangular in cross section and/or as a non-cylindrical shaped outer periphery, it should be understood that the shaft may be a variety of shapes, sizes, quantities, and constructions and still be within the scope of the invention.

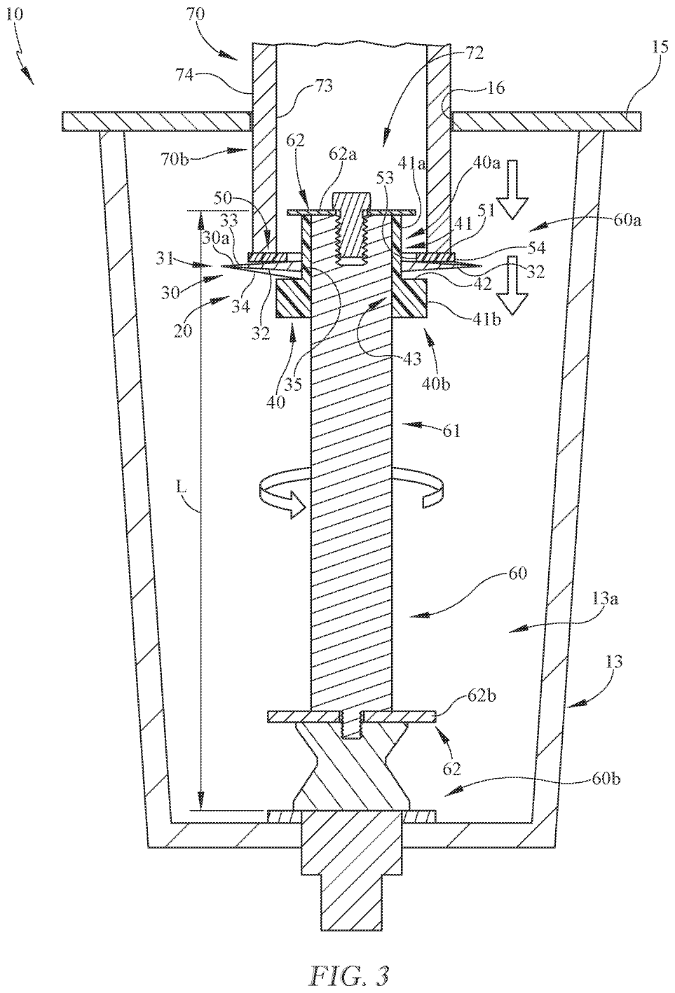

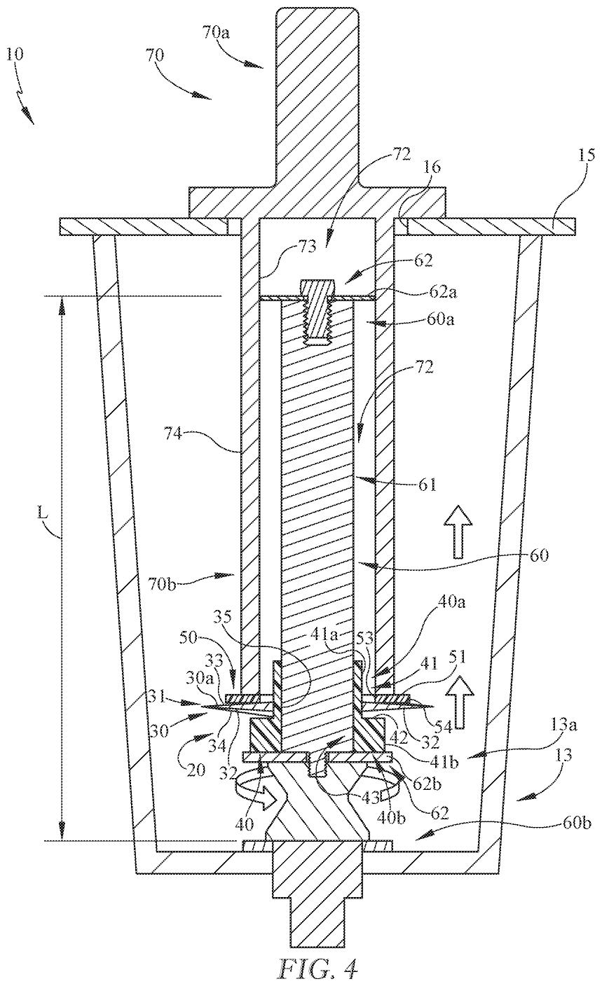

In some implementations, the shaft 60, blender 10, and/or blade assembly 20 may include a one or more limit/stop mechanisms 62 along the shaft 60 and/or at one or more elevations. The stops or abutments 62, if used, may limit the travel (e.g. vertical, linear, sliding) of the blade assembly 20, or portions thereof, in one or more directions. In the one embodiment shown, the stop mechanism 62 for limiting the travel of the blade assembly 20, or portions thereof, may include one or more members or flanges 62a, 62b positioned at one or more elevations of the shaft 60. The shaft 60 may include an upper member 62a adjacent the upper end 60a of the shaft 60. The upper member 62a may stop the upward vertical travel of the blade assembly 20, or portions thereof, (e.g. bushing, blade, washer). For example, the upper member 62a of the shaft 60 may be a vertical stop or upper limit at a first or upper elevation as shown in FIG. 3. The shaft 60 may include a lower member 62b adjacent the lower end 60b of the shaft 60. The lower member 62b may stop the downward vertical travel of the blade assembly 20, or portions thereof, (e.g. bushing, blade, washer). For example, the lower member 62b of the shaft 60 may be a vertical stop or lower limit at a second or lower elevation as shown in FIG. 4. One or more of the stop mechanisms 62 may be vertically fixed along the length L or at an elevation of the shaft 60 and/or be rotatable relative to the shaft 60. In the one embodiment shown, the upper member 62a and/or the lower member 62b may be a washer fixed along the length L at an elevation and is rotatable relative to the shaft 60. Although not shown, it should be understood that the one or more stop mechanisms may be rotatably fixed to the shaft and/or travel vertically along the shaft in some embodiments.

In some implementations, the blade assembly 20, shaft 60, and/or blender 10 may include one or more blades 30. As shown in the one embodiment, the blade assembly 20 may include one or more blades 30 in one or more positions/elevations. The one or more blades 30 may include a first blade 30a that includes a plurality of blade ends/wings/protrusions 32 extending away from the body 31. Although a single first blade 30a having one or more protrusions 32 is shown in the one embodiment, a plurality of blades 30 may be used (e.g. first blade, second blade, etc.). The first blade 30a may include a plurality of blade protrusions 32. A protrusion 32 may have a leading edge 32a and a trailing edge 32b. The body 31 or blade(s) 30 may include a top surface 33 and a bottom surface 34. The body 31 may include a through opening 35 extending through the body 31 and/or between the top surface 33 and the bottom surface 34. The through opening 35 receives the shaft 60 and/or bushing 40 throughout the elevations of the blade assembly 20. The one or more blades 30 rotationally lock with the shaft 60 and/or bushing 40, if used, and vertically travels along the shaft 60. As shown in the one embodiment, the blade 30 or through opening 35 engages the outer periphery 41 of the bushing 40. It should be understood that the blade may be a variety of shapes, sizes, quantities, and constructions and still be within the scope of the invention.

In some implementations, the blade assembly 20, shaft 60, blade(s) 30, and/or blender 10 may include one or more bushings/sleeves 40. The blade assembly 20 may include at least one bushing 40 as shown in the one embodiment. The one or more bushings 40, if used, and the one or more blade(s) 30 may be configured to be rotationally fixed to the shaft 60 and vertically travel/slide along the shaft 60. The one or more bushings 40 may include a though opening 43 therein receiving (e.g. slidably) the shaft 60 through/at the elevations of the blade assembly 20. The bushing 40 may be positioned between the one or more blades 30 and the shaft 60. The bushing 40 may provide a sliding contact surface against/with the shaft. The bushing 40 may provide for more efficient sliding, reduce friction, and reduce binding with and/or between the shaft and/or blade. The bushing 40 and/or the blade(s) 30 may be rotatably driven with the shaft 60 by the drive mechanism 12. The one or more bushings 40 and the one or more blades 30 may travel (e.g. vertically, slidably) along the shaft 60 when rotatably driven and/or not driven by the shaft/drive mechanism. The one or more bushings 40, or portions thereof, may abut or contact (e.g. directly) stop mechanism 62 (e.g. the upper member 62a and/or lower member 62b) of the shaft 60 when traveling/sliding along the shaft (e.g. vertically, downward, upward). This may stop the travel of blade assembly 20 in one or more directions. In the one embodiment shown in the figures, the bushing 40 (e.g. body) may include an upper portion 40a and a lower portion 40b. The upper portion 40a may include an outer periphery 41a that is smaller than the outer periphery 41b of the lower portion 40b. A step/ledge/flange 42 (e.g. horizontal surface, surface having inner edge to outer edge) may be between or defined by the upper portion 40a (e.g. outer periphery) and the lower portion 40b (e.g. outer periphery). The inner periphery may define the through opening 43 of the bushing 40 that may contour or be shaped to match the outer periphery 61 of the shaft 60 in some embodiments. The one or more blades 30 may rest upon, engage, and/or directly abut/contact the bushing 40, or portions thereof (e.g. step, through opening, inner periphery, outer periphery). For example, the bottom surface 34 of the blade 30 may contact the step 42. The through opening 35 of the blade 30 may engage or contact the outer periphery 41 of the bushing 40 (e.g. the upper portion 40a, outer periphery 41a). The bushing 40 may rotationally lock to the shaft 60 and/or blade 30 while allowing vertical travel (e.g. upwardly, downwardly). The bushing 40 may rotationally/axially lock to the one or more blades 30 and/or rotationally lock the one or more blades 30 to the shaft 60 while allowing vertical travel (e.g. upwardly, downwardly). Stated alternatively, the one or more blades 30 may rotationally/axially lock to the bushing 40, or portions thereof. It should be understood that the bushing 40 may be a variety of shapes, sizes, quantities, and constructions and still be within the scope of the invention. The bushing may be made of a variety of materials such as, but is not limited to, a nylon, polypropylene, plastic, or the like. In some embodiments, the bushing may have a low coefficient of friction with the shaft. Further for example, the bushing may have a lower coefficient of friction than the blade.

In some implementations, the blade assembly 20, shaft 60, blade(s) 30, bushing 40, and/or blender 10 may include one or more washers 50. The blade assembly 20 may include at least one washer 50 as shown in the one embodiment. Although the washer 50 is shown as freely rotating relative to the shaft 60, blade 30, bushing 40 and/or remaining portion of the blade assembly 20, it should be understood that the washer may be rotationally fixed to the shaft, blade, bushing, and/or remaining portion of the assembly in some embodiments. The washer 50, if used, may travel (e.g. vertically, upwardly, downwardly) with the blade assembly 20, blade 30, and/or bushing 40 along the shaft 60. The one or more washers 50 may include an inner periphery or though opening 53 therein receiving the blade 30, shaft 60, and/or bushing 40, if used, through/at the elevations of the blade assembly. The washer 50 may be positioned above and/or engage the blade 30 (e.g. top surface). The washer 50 may be arcuate having an inner periphery 53 at a first radius and an outer periphery 54 at a second radius, larger than the first radius. It should be understood that the washer may be a variety of shapes, sizes, quantities, and constructions and still be within the scope of the invention. The washer may be made of a variety of materials such as, but is not limited to, a nylon, polypropylene, plastic, or the like. Further, the washer (e.g. tamper contact surfaces) may be fixed to or be a portion of the bushing and/or blade. For example, the washer may not be a separate structure/member to the bushing and/or blade.

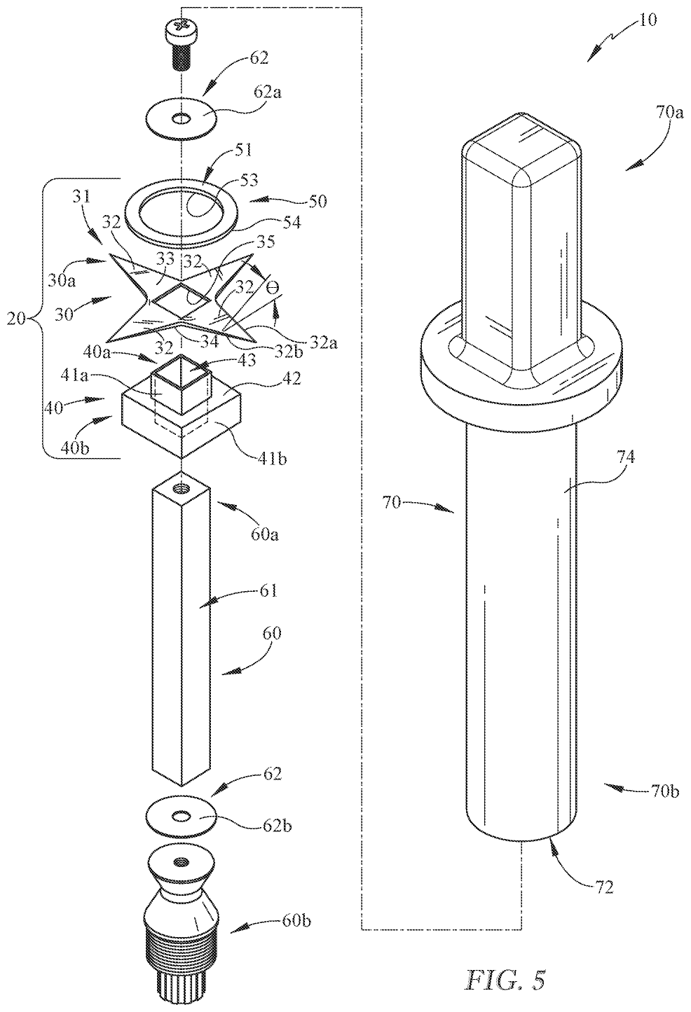

In some implementations, the blade assembly 20, shaft 60, blade(s) 30, washer 50, bushing 40, and/or blender 10 may include one or more tampers 70. The tamper 70, if used, may be used for tamping the contents within one or more portions of the appliance (e.g. blender, interior, container, etc.). At least one tamper 70 may be used to force/urge the blade assembly 20 (e.g. washer, bushing, and/or blades) downwardly along the shaft 60 while the blade assembly is rotating and/or not rotating when in one or more elevations along the length of the shaft. The tamper 70 may be used during/after/before blending the content(s) and/or used when the blade assembly 20 is at one or more elevations of along the shaft 60. In some embodiments, the tamper 70 may be used repeatedly to push the blade assembly 20 down (e.g. for one or more lengths) after allowing the rotating blade assembly to automatically travel up (e.g. push down effect) or recover its upward travel. The tamper 70 may be manually moved or inserted by the user within the container 13 (e.g. interior 13a, opening 16) in some applications to releasably engage the blade assembly 20, bushing 40, blade 30, and/or washer 50, if used, and maintain the blade assembly at an elevation, drive/push the blade assembly from a higher elevation to a lower elevation, and/or allow the blade assembly to rise from a lower elevation to a higher elevation (e.g. disengage the tamper from the blade assembly, reduce downward force from the tamper to the blade assembly while still engaged, lift/raise tamper up). As shown in FIGS. 3, 4, and 5, the tamper 70 may releasably engage the washer 50, or portions thereof (e.g. top surface 51). The user may selectively use the tamper 30 to drive the blade assembly up/down along the shaft 60.

In some implementations, the tamper 70 may extend through the opening 16 of the lid 15 to releasably engage the washer 50 and/or blade assembly 20, or portions thereof. The tamper 70 may drive/adjust the washer 50, bushing 40, and/or the blade(s) 30 vertically downward/upward along the shaft 60. The tamper 70 may drive/adjust the washer, bushing, and/or blade(s) downwardly/upwardly when the shaft 60, blade 30, and bushing 40 is rotating or not rotating. Reducing/removing the downward force upon the blade assembly, or portions thereof, by the tamper 70 may allow the blade assembly 20 to vertically travel away (e.g. upward) from its current/lower elevation in which the downward force was removed or reduced. The tamper 70 (e.g. body) may include a distal end 20a and a proximal end 70b. The proximal end 70b may releasably engage the blade assembly 20 (e.g. bushing, blade, washer). As shown in the one embodiment, the proximal end 70b may releasably engage the washer, if used. The proximal end 70b may include a receptacle 72. The proximal end 70b may abut or directly contact the top surface 51 of the washer 50. The receptacle 72 may receive the upper member 62a, stop mechanism 62, shaft 60, bushing 40, washer 50, or portions thereof, or one or more portions of the blade assembly. As shown in the one embodiment, the upper member 62a, upper end 60a, bushing 40 (e.g. upper portion) and/or a portion of the length L of the shaft 60 may be received within the receptacle 72. The portion of the length L of the shaft 60 received by the receptacle 72 will increase as the tamper 70 drives the washer 50 (e.g. rotating, not rotating), blade assembly 20, the bushing 40, washer 50, and/or blades 30 vertically downward along the shaft 60. The portion of the length L of the shaft 60 received by the receptacle 72 will decrease as the tamper 70 allows the washer 50 (e.g. rotating), blade assembly 20, the bushing 40, and/or blade 30 vertically upward along the shaft 60. The tamper 70 may telescope with the shaft 60 and/or blade assembly 20, or portions thereof, when vertically moving the bushing and/or blade downwardly/upwardly when rotatable driven. The proximal end 70b of the tamper 70 may include an inner periphery 73 (e.g. circular) and/or outer periphery 74 (e.g. circular). The arcuate or circular proximal end 70b (e.g. hollow cylinder, distal end) may releasably engage/abut the circular or arcuate washer 50 as shown in the one embodiment. When the tamper 70 is engaged with the washer 50, the tamper 70 may be rotational fixed or engaged to the washer 50 while allowing the bushing 40 and/or blade 30 to rotate. The inner periphery 73 of the tamper or proximal end 70b may be larger than the outer periphery 61, 41 of the upper end 60a/member 62a and/or bushing 40, respectively. Alternatively, the washer 50 may rotate relative to the proximal end 70b of the tamper 70 when the tamper is engaged to the washer. The tamper 70 may allow the shaft 60, bushing 40, washer 50, and/or blade 30 to rotate when the tamper is engaged to the blade assembly 20 and/or washer 50 in one or more elevations. Although not shown, it should be understood that the tamper may engage the bushing and/or blade in some embodiments. For example, when a washer is not used in some embodiments. It should be understood that the tamper may be a variety of shapes, sizes, quantities, and constructions and still be within the scope of the invention.

In some implementations, the engagement between the blade assembly 20, or portions thereof, and the shaft 60, or portions thereof, may be a variety of engagements/constructions and still be configured to rotational lock and provide axial movement therebetween. Although the blade assembly 20 (e.g. bushing) and the shaft 60 have a rotational lock/interference of contacting surfaces/structure (e.g. inner periphery 43 with the outer periphery 61, rectangular outer periphery 61 engaging a rectangular inner periphery 43) therebetween to rotational lock and allow vertical sliding/movement, a variety of engagements may be used and still be within the scope of the invention. For example, a pin and slot engagement between the blade assembly (e.g. bushing) and the shaft may be used. Although not shown, an elongated slot may be positioned along the length of the shaft and the bushing and/or blade assembly may include a pin slidably engaging the slot. Further for example, the outer periphery 61 of the shaft may be oval in shape and the inner periphery 43 of the bushing may be oval in shape thereby preventing rotation and allowing vertical travel therebetween.

In some implementations, although not shown, the blade assembly and/or blender may include a bias mechanism urging the blade assembly upwardly and/or downwardly.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. A blender comprising:
a base having a drive mechanism;
a shaft rotatably driven by the drive mechanism;
a blade assembly having a bushing and one or more blades, wherein the bushing is positioned between the one or more blades and the shaft, and wherein the bushing and the one or more blades are rotatably driven with the shaft by the drive mechanism;
a container removably attached to the base, wherein the container includes the shaft and the blade assembly therein; and
wherein the bushing and the one or more blades vertically travel along the shaft when rotatably driven with the shaft.

2. The blender of claim 1 further comprising an upper member and a lower member positioned on the shaft, wherein upward vertically travel of the bushing and the one or more blades is stopped by the upper member and downward vertically travel of the bushing and the one or more blades is stopped by the lower member.

3. The blender of claim 2 wherein the bushing directly abuts the upper member and the lower member when upward vertical travel and downward vertical travel is stopped, respectively.

4. The blender of claim 2 wherein the upper member and the lower member are vertically fixed along the shaft and rotatable relative to the shaft.

5. The blender of claim 1 wherein the blade assembly includes a washer vertically traveling along the shaft with the bushing and the one or more blades, and wherein the washer freely rotates relative to the shaft.

6. The blender of claim 5 further comprising a tamper and wherein the container includes a lid defining an opening, wherein the lid is removably attached to the container, and wherein the tamper extends through the opening of the lid and releasably engages the washer to drive the washer, the bushing, and the one or more blades vertically downward along the shaft.

7. The blender of claim 6 wherein the tamper includes a distal end and a proximal end, wherein the proximal end includes a receptacle, and wherein the proximal end releasably engages the washer when the receptacle of the proximal end receives the shaft, a length of the shaft within the receptacle increases as the tamper drives the washer, the bushing, and the one or more blades vertically downward along the shaft.

8. The blender of claim 1 wherein the bushing includes an upper portion and a lower portion, wherein an outer periphery of the upper portion is smaller than an outer periphery of the lower portion defining a step therebetween.

9. The blender of claim 8 wherein the one or more blades includes a top surface and a bottom surface with a through opening therebetween, and wherein the through opening contacts the outer periphery of the upper portion of the bushing and the bottom surface contacts the step of the bushing.

10. The blender of claim 1 wherein the bushing rotationally locks to the shaft while allowing vertical travel along the shaft.

11. The blender of claim 1 wherein the one or more blades rotationally locks to the bushing while allowing vertical travel along the shaft.

12. A blender blade assembly comprising:
one or more bushings;
one or more blades, wherein the one or more blades engages the one or more bushings; and
wherein the one or more bushings and the one or more blades are configured to be rotational fixed to and vertically travel along a shaft.

13. The blender blade assembly of claim 12 further comprising a washer, wherein the washer is configured to vertically travel along a shaft with the one or more bushings and the one or more blades.

14. The blender blade assembly of claim 13 wherein the washer freely rotates relative to the one or more bushings.

15. The blender blade assembly of claim 12 wherein the bushing includes an upper portion and a lower portion, wherein an outer periphery of the upper portion is smaller than an outer periphery of the lower portion defining a step therebetween.

16. The blender blade assembly of claim 15 wherein the one or more blades includes a top surface and a bottom surface with a through opening therebetween, and wherein the through opening contacts the outer periphery of the upper portion of the bushing and the bottom surface contacts the step of the bushing.

17. The blender blade assembly of claim 12 further comprising a shaft having an upper member and a lower member positioned on the shaft, wherein upward vertically travel of the one or more bushings and the one or more blades is stopped by the upper member and downward vertically travel of the one or more bushings and the one or more blades is stopped by the lower member.

18. The blender blade assembly of claim 17 wherein the one or more bushings directly abut the upper member and the lower member when upward vertical travel and downward vertical travel is stopped, respectively.

19. The blender blade assembly of claim 17 wherein the upper member and the lower member are vertically fixed along the shaft and rotatable relative to the shaft.

20. The blender blade assembly of claim 12 further comprising a base, a drive mechanism, and/or a container.

21. A method of mixing the contents of a blender container comprising the steps of:
providing a blender having a base and a container removably attached to the base, wherein the base includes a drive mechanism, wherein the container includes a lid defining an opening, and wherein the lid is removably attached to the container;
providing a blade assembly engageable to the drive mechanism of the base, wherein the blade assembly having a bushing and one or more blades, wherein the bushing is positioned between the one or more blades and the shaft;
rotatably driving the bushing and the one or more blades with the shaft by the drive mechanism; and
vertically moving the bushing and the one or more blades upwardly when rotatably driven.

22. The method of claim 21 further comprising inserting a tamper through the opening of the lid into an interior of the container, engaging the blade assembly with the tamper, and vertically moving the bushing and the one or more blades downwardly when rotatable driven with the tamper.

23. The method of claim 22 further comprising increasingly telescoping the shaft relative to the tamper when vertically moving the bushing and the one or more blades downwardly when rotatable driven with the tamper.

24. The method of claim 21 further comprising stopping the vertical movement of the blade assembly with an upper member and a lower member positioned on the shaft.

25. The method of claim 21 wherein the blade assembly includes a washer vertically traveling along the shaft with the bushing and the one or more blades.
